(19) United States
(12) Patent Application Publication
(10) Pub. No.: US 2016/0284026 A1
(43) Pub. Date: Sep. 29, 2016

(54) INVESTMENT ADVISOR SYSTEM AND METHOD

(71) Applicant: Rohan Kulkarni, Springboro, OH (US)

(72) Inventor: Rohan Kulkarni, Springboro, OH (US)

(21) Appl. No.: 15/095,128

(22) Filed: Apr. 10, 2016

Related U.S. Application Data
(63) Continuation-in-part of application No. 13/021,746, filed on Feb. 5, 2011.

(51) Int. Cl. G06Q 40/06; G06Q 30/02; G06F 17/30

(52) U.S. Cl. CPC G06Q 40/06; G06F 17/3053; G06Q 30/0201

(57) ABSTRACT

A computer based system for generating an investment advice report. The system comprises a processor unit and a computer readable medium. The computer readable medium stores instructions executable by the processor unit. The instructions are executable to receive input comprising information associated with identification of an investment broker, one or more fund families and/or investment sectors associated with the investment broker, and a risk level. The instructions are also executable to identify a plurality of securities associated with the investment broker and the one or more fund families and/or investment sectors. The instructions are executable to receive a first market research information associated with the identified securities and to process the risk level in combination with the first market research information. The instructions are executable to generate a first investment advice report indicating apportioning of the sum of the money among the identified securities.

### CROSS-REFERENCES TO RELATED APPLICATIONS

This present application is a continuation in part of commonly owned U.S. patent application Ser. No. 13/021,746, entitled “ INVESTMENT ADVISOR SYSTEM AND METHOD,” filed on Feb. 5, 2011, which is herein incorporated by reference.

### BACKGROUND OF THE INVENTION

The present invention is generally related to computer-based investment advisor system and method.

An individual often needs to invest money to fund the future expenses. For example, people often invest for retirement via the employer sponsored plans such as 401K, 457 and any other. As another example, people can also invest for retirement via the Individual Retirement Accounts (Traditional IRA, Roth IRA etc.). As yet another example, people often invest for the children's or grand-children's education via the college saving plans such as 529 plan offered by various states and others. Often times, people also invest in stocks and mutual funds in order to grow their wealth.

These days, there is overwhelming number of investment options available. Further, the dynamics of the financial markets is so complex, that the individual is often unable to make judicious investment decision on his own. To compound this problem, everyone does not have access to or cannot afford the services of the skilled investment advisors.

In view of the foregoing, improved techniques for investment advising are desirable, that are preferably easily accessible and are easy to use. The present invention provides such techniques.

### SUMMARY OF THE INVENTION

It is an object of the present invention to provide computer-based investment advisor system and method. Advantageously, the techniques for investment advising according to the present invention are easy to use requiring few and easily understood inputs from the user. Moreover, they provide an investment advice to the user which is easy to understand and concrete. In an embodiment, the present invention provides the investment advisor system that is based on easily available computing technologies, such as web-based computing technologies.

In a specific embodiment of the present invention, a computer based system is provided for generating an investment advice report. The system comprises a processor unit and a computer readable medium storing instructions executable by the processor unit. The processor executes the instructions to perform the steps of receiving input comprising information associated with identification of a plurality of securities and a risk level of the investor, receiving a market research information associated with the securities identified in the input, processing the input in combination with the market research information, and generating the investment advice report indicating apportioning of investment among the securities identified in the input. In alternative embodiments, the invention also provides methods related to generating the investment advice report.

These and other various objects, features, advantages, and benefits of the present invention can be more fully appreciated with reference to the detailed description and accompanying drawings that follow.

### BRIEF DESCRIPTION OF THE DRAWINGS

The present invention is generally related to computer-based investment advisor system and method. Traditionally, certain computer based algorithms and software tools are available which can aid in making certain investment decisions. However, it is often found that such tools are either non-specific in recommendations on one hand or too complex requiring understanding of the investment field as a science on the other. A non-specific investment advisor tool often gives a generic response on what percentage should be invested in cash, stocks, and bonds, without getting into details of particular securities. On the other hand, too complex input and output based systems require understanding of realistic economic assumptions, savings rates, and understanding of risk scale. The output consisting of probability based likelihood of achieving desired savings objectives, or the various scenarios based output prompts more questions than the answer.

Certain other conventional investment advising tools, often called as “stock screeners” provide for searching for securities which match certain investor specified criteria. However, these tools often provide mere listing of securities and do not tell the investor how the investment should be apportioned into these various securities. They thus fall short of providing concrete investment advice.

The present invention provides improved investment advisor system and method to overcome certain limitations of the conventional techniques. Embodiments of the present invention are illustrated in the figures of the accompanying drawings. These figures are exemplary and they should not unduly limit the scope of the invention. The figures are provided to aid thorough disclosure of the invention. Based on the present disclosure, person of ordinary skill in the art can contemplate various alternatives, variations and modifications to the illustrated embodiments within the scope of the invention disclosed herein.

FIG. 1 illustrates an exemplary computer network system that can provide an environment to practice the present invention according to a specific embodiment.

FIG. 2 illustrates an exemplary computer apparatus that can provide a computing platform to practice the present invention in accordance with a specific embodiment of the present invention.

FIG. 3 illustrates an exemplary schematic of a system for investment advising according to a specific embodiment of the present invention.

FIGS. 4A, 4B, 4C and 4D illustrate exemplary computer screenshots for receiving investor input according to a specific embodiment of the present invention.

FIG. 5 illustrates an exemplary output of a sorting module in the investment advising system according to a specific embodiment of the present invention.

FIG. 6 illustrates an exemplary output of a ranking module in the investment advising system according to a specific embodiment of the present invention.

FIGS. 7A, 7B, 7C and 7D illustrate certain exemplary market information and certain exemplary output of a ranking module in the investment advising system according to specific embodiments of the present invention.

FIGS. 8A and 8B illustrate certain exemplary weight assignment templates used by a risk filtering module in the investment advising system according to a specific embodiment of the present invention.

FIG. 9 illustrates an exemplary investment advice report according to an embodiment of the present invention.

FIG. 10 illustrates an exemplary feedback loop in the investment advisor system according to an embodiment of the present invention.

FIG. 11 illustrates an exemplary schematic of a Feedback Module in a system for investment advising according to a specific embodiment of the present invention.

### DETAILED DESCRIPTION OF THE INVENTION

The following detailed description of the invention refers at various places to the accompanying drawings and specific environments, applications, platforms, examples, computer screenshots, and implementations. The detailed description is provided for thorough understanding of the present invention and is illustrative rather than limiting.

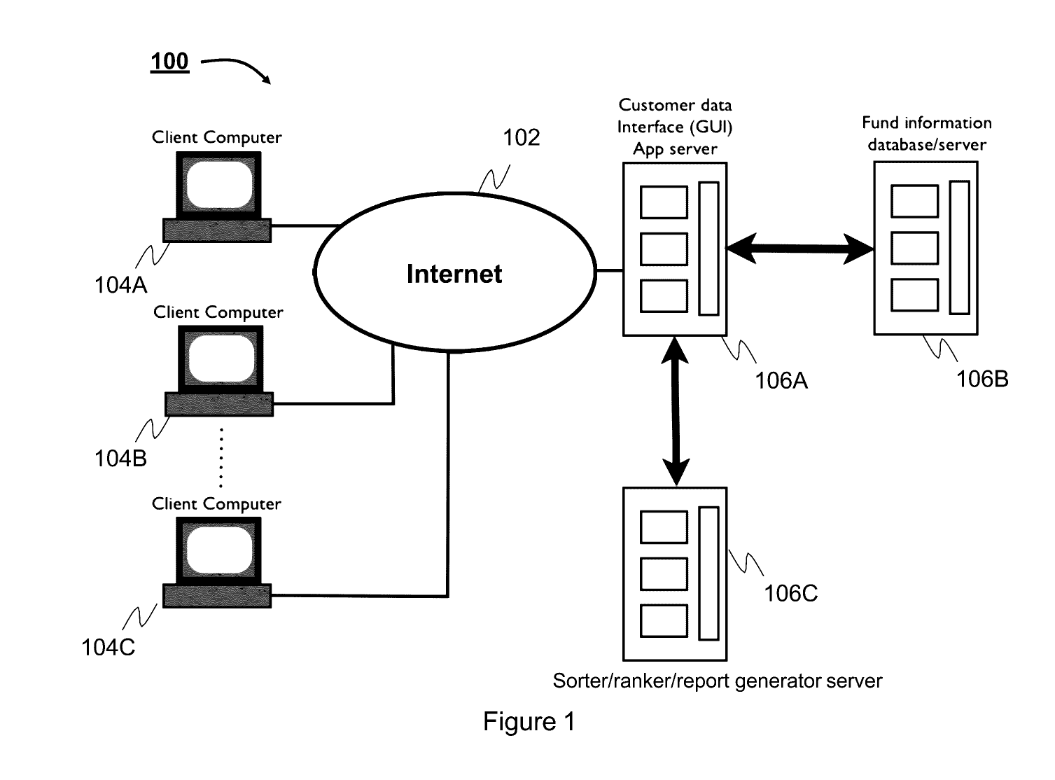

FIG. 1 illustrates an exemplary computer network system 100 which can provide an environment to practice certain specific embodiments of the present invention. As shown in FIG. 1, multiple end user computer systems 104 and multiple server computer systems 106 can be coupled to a telecommunication network 102. For example, the telecommunication network 102 can include the Internet. The end user computer systems 104 can include without limitation desktop computers, laptop computers, personal digital assistant (PDAs), and smart phones. The computer systems 104, 106 etc. can exchange information using the telecommunication network 102.

The servers 106 store digitized content which can be accessed (e.g., read, downloaded, bookmarked, searched, acted upon, changed etc. as appropriate) over the Internet. A specific portion of the content is often identified using a hyperlink and can be accessed from computer systems 104 via web browser (e.g., Internet Explorer provided by Microsoft Corporation, Mozilla Firefox provided by open source community etc.) and other applications. The content stored in one server can also be accessed by another server. Popular techniques for accessing the content include HTTP and (HyperText Transfer Protocol) and HTTPS (HypterText Transfer Protocol Secure), though other techniques can also be used. The content can be in any of the formats such as HTML (HypterText Markup Language), XML, DHTML, XHTM, PDF, MS Word, JSON and others. Access to some portions of the content may require authorization for access.

In this embodiment, the servers 106 can be configured to perform certain acts according to the present invention. For example, the servers 106 can include software instructions which can facilitate performing these acts. In an embodiment, the server 106A can perform the end user interaction function, the server 106B can maintain market research information, and the server 106C can perform sorting, ranking and filtering functions according to the present invention. Depending upon the embodiments, these servers can also perform additional functions such as payment gateway (e.g., if the investment advice is provided at cost), securities brokering etc. Alternatively, additional servers can be provided to perform these additional functions.

The specific arrangement shown in FIG. 1 is exemplary only and should not unduly limit the scope of the invention. For example, in an embodiment, the servers 106 can be hosted in a data center and they can interact over the local area network. In an alternative embodiment, the servers 106 can be deployed in a distributed fashion and can interact over the Internet. According to yet an alternative an embodiment, two or more of the servers 106 can be provided in a single computer system. In yet a further alternative embodiment, at least one of the servers can comprise plurality of interconnected computers. As another example, a subset of acts according to the present invention is performed by servers and another subset of acts according to the present invention is performed within the user computer system 104. Such and other various alternatives and modifications will be apparent to person of ordinary skill in the art and they are included within the scope of the present invention.

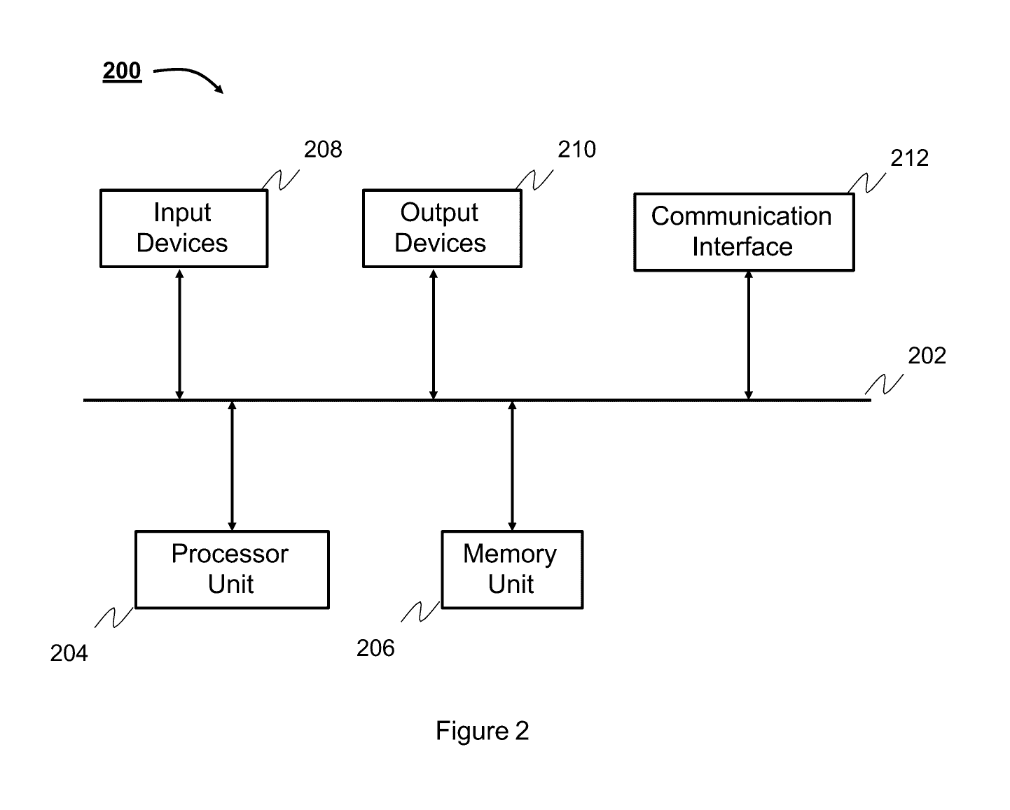

FIG. 2 illustrates an exemplary implementation of any of the servers 106 according to an embodiment of the present invention. The server may include a bus 202, a processor unit 204, a memory unit 206, one or more input devices 208, one or more output devices 210, and a communication interface 212. The bus 202 permits communication among the components of the server. The processor unit 204 may include one or more microprocessors, microcontrollers, RISC processors, CISC processors etc. The processor unit can interpret and execute instructions. The memory unit 206 may include any type of one or more volatile storage devices, for example, random access memory (RAM). The memory unit 206 may in addition or alternatively include any type of one or more persistent storage devices, for example read only memory (ROM), read write memory, hard disc, flash memory etc. The memory unit stores information and instructions for execution by the processor unit 204.

The input devices 208 may include one or more mechanisms that permit an operator to input information into the server, such as a keyboard, mouse, pen, magnetic drives, optical drives etc. The output devices 210 may include one or more mechanisms that output information to the operator, including a display, a printer, a speaker etc. The communication interface 212 may include any transceiver mechanism that enables the server to communicate with other devices and systems via a network. For example, the communication interface can include Ethernet interface, optical network interface, wireless interface etc.

Any of the user computer systems 104 can also include CPU (central processing unit), one or more memory units (RAM, ROM, flash memory, had disc etc.), display unit, and network interfaces (Ethernet, Wi-Fi, 3G etc.).

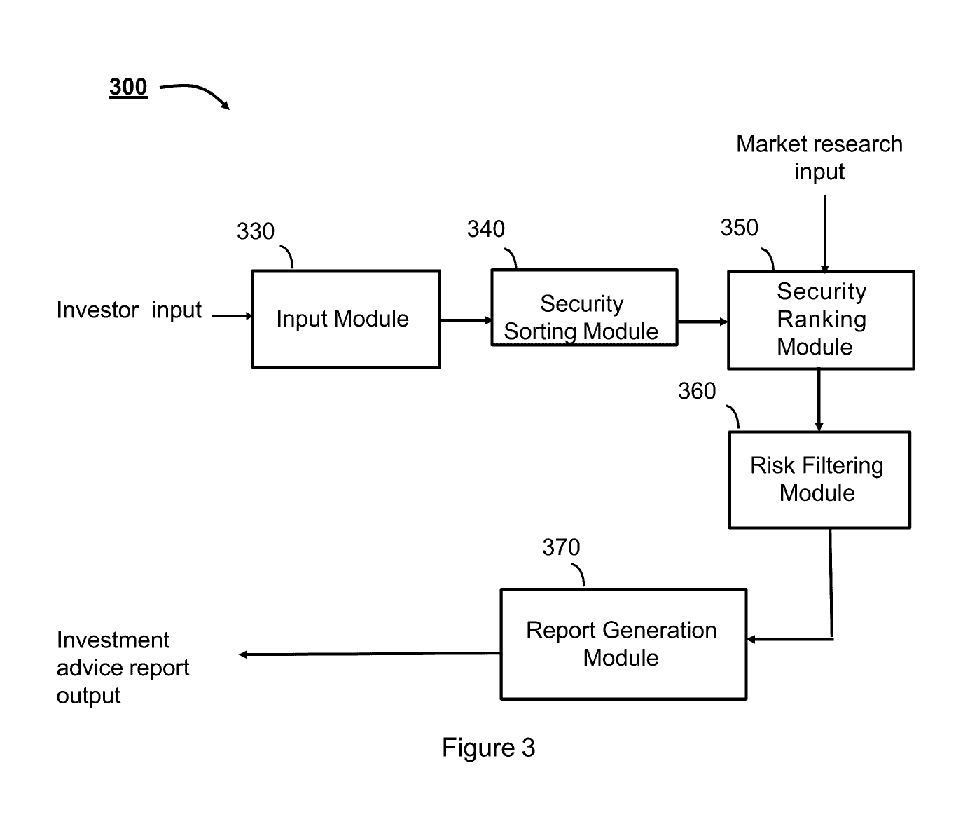

FIG. 3 illustrates an exemplary schematic of a system 300 for investment advising according to a specific embodiment of the present invention. As shown in FIG. 3, the system 300 comprises various modules. Each of these modules can be a hardware module, a software module or combination thereof. Moreover, depending upon the embodiment, each of the modules can reside on a single computer system or can be distributed across a plurality of interconnected computers.

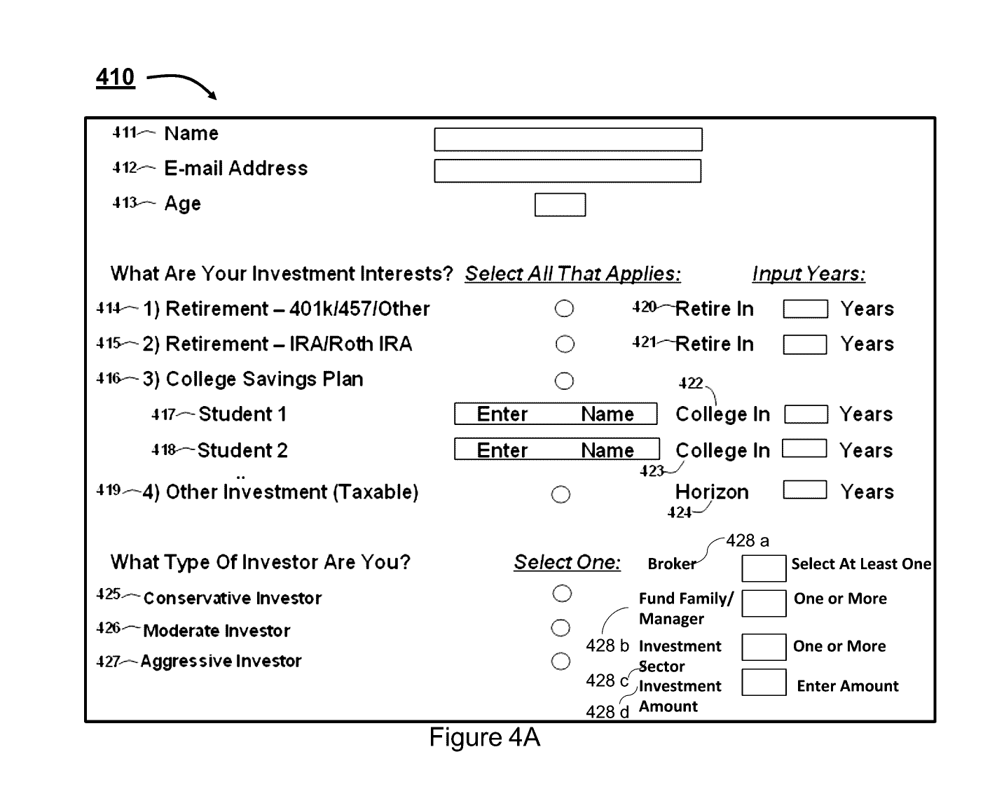

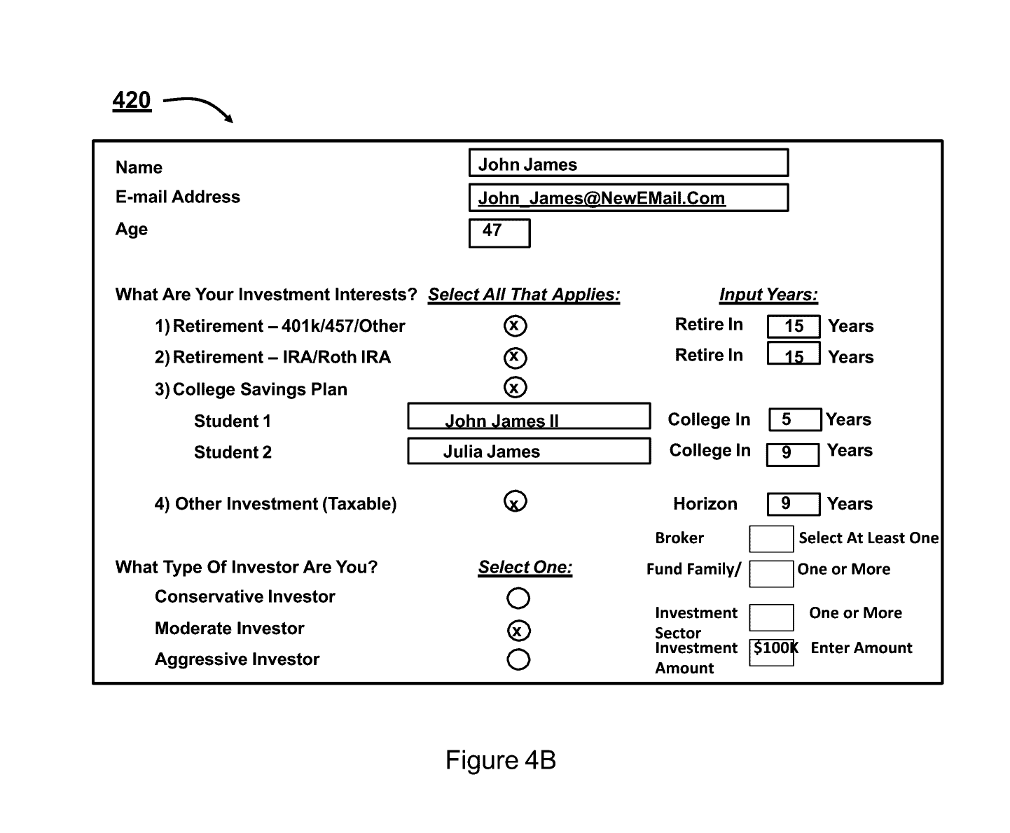

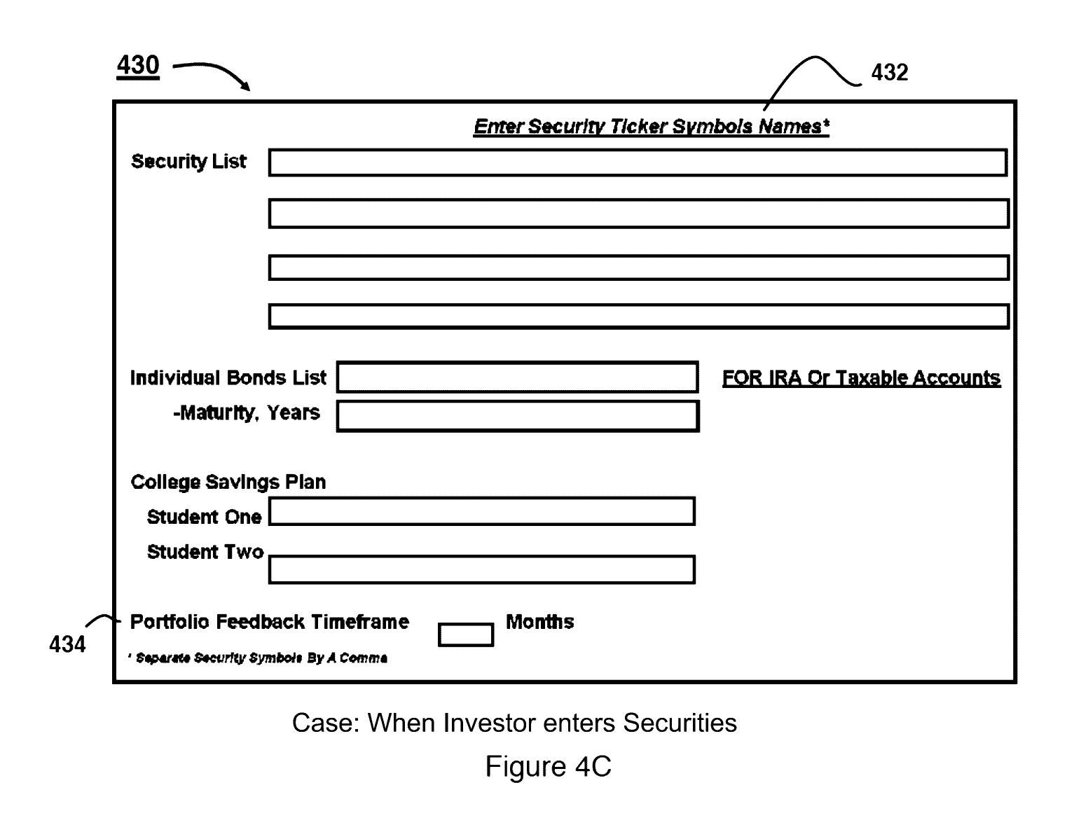

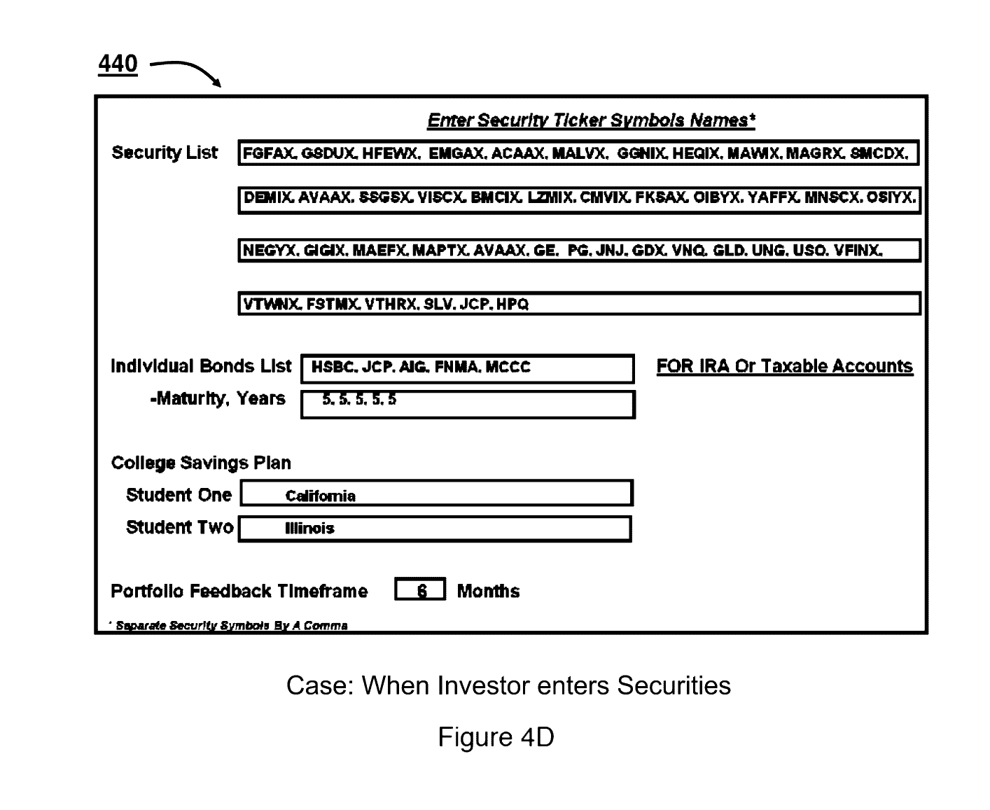

As shown in FIG. 3, the system comprises an Input Module 330. The input module facilitates receiving the investor input into the system. In an embodiment of the present invention, the investor/user can select at least one broker, at least one fund family/fund manager, at least one financial investment sector, and inputs amount of funds to be invested. Selection and/or input by the investor/user can be facilitated via one or more drop down menus, user typing the input, etc. In an alternative embodiment of the present invention, investor/user can input financial securities of interest to get advice on. As an illustrative example, the input module can display a web page on the end user system 104, wherein the web page comprises a plurality of fields where the user can provide different portions of the investor input. The investor input can then be communicated to the server 106A over the computer network. Some exemplary computer screenshots 410, 420, 430 and 440 for receiving the investor input are illustrated in FIG. 4A, FIG. 4B, FIG. 4C and FIG. 4D, respectively.

As shown in FIG. 4A, the investor input can indicate one or more of the investment interests such as retirement (414, 415), college saving (416-418) and others (419). The investor input can also indicate the investment time horizon (420-424) as well as the level of risk the investor is willing to take, for example, as conservative, moderate or aggressive (425-427). In an embodiment, the investment time horizon entered by the investor can be used to perform sanity check on the input and/or guide the investor to input appropriate information. As merely an example, if the investor is of age 62 and needs money in two years to take care of expenses, then in most likely case, “aggressive” choice of risk level may not be appropriate and thus can be advised to the investor. The investor input can also comprise other information such as name, email address and age of the investor (411-413). The investor input can include selection of at least one broker (428a), selection of at least one mutual fund family/mutual fund manager (428b), at least one financial investment sector (428c), and amount of money to be invested (428d). Alternatively in field 428b, the investor/user selects at least one exchange traded fund family/exchange traded fund manager. Exemplary computer screen shot illustrating exemplary input provided by the investor is shown in FIG. 4B.

As shown in FIG. 4C, the investor input can further indicate identities of the specific securities that the investor wants to be included in the investment analysis. For example, in the 401k scheme, these specific securities can be all or a subset of securities that are allowable for investment in the 401k plan. As another example, in the Individual Retirement Account (IRA or Roth IRA), these specific securities can include individual company stocks, individual company bonds, mutual funds, and Exchange Traded Funds (ETFs). As yet another example, in the taxable investment category, these specific securities can be the securities that the investor has found via other means such as market reports, friends, favorite companies etc. As another example, in the college savings plans, the investor can indicate specific plan names such as different states' college saving plans. The investor can indicate securities identities using ticker symbols, plan names or any other appropriate identifiers for the securities (432). The investor can also indicate the portfolio feedback time. In a specific embodiment, the system uses a default portfolio feedback time (say 12 months merely as example); however user can customize this time by inputting the desirable time period (at input field 434). Exemplary computer screen shot illustrating exemplary input provided by the investor is shown in FIG. 4D.

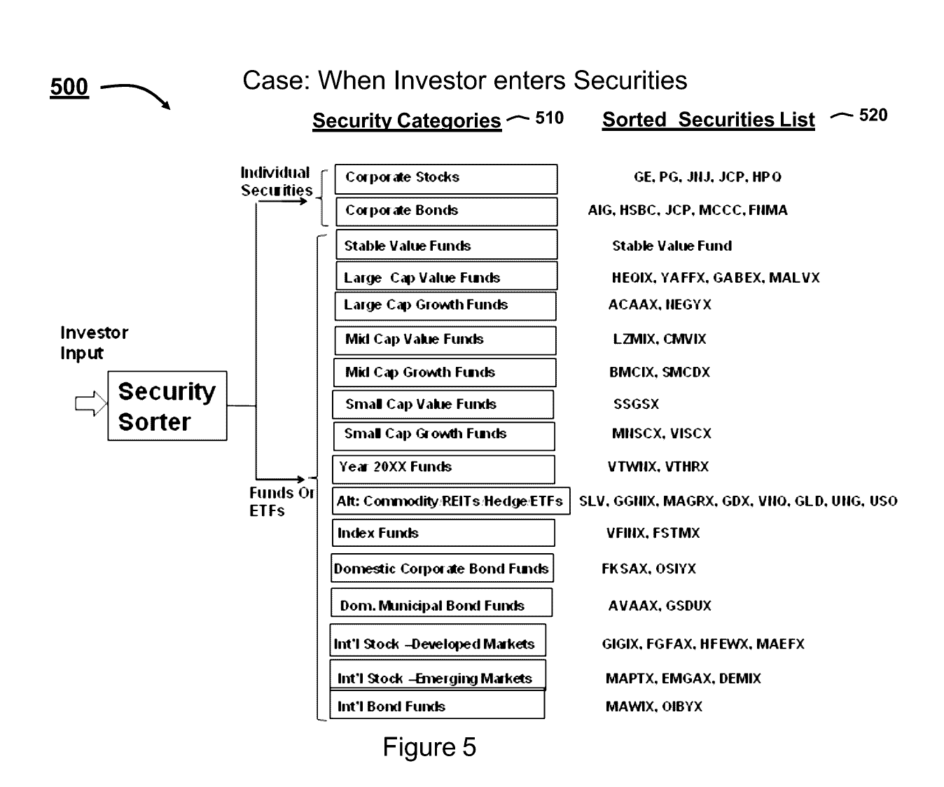

Referring to the embodiment illustrated in FIG. 3, the system 300 includes a Security Sorting Module 340. This module processes the investor input gathered by the Input Module 330 and classifies the securities identified in the investor input into a plurality of categories. Exemplary categories include company stocks, individual company bonds, government agency/municipality bonds, mutual funds and ETFs as well as finer classifications thereof. In an embodiment of present invention, illustrated in 428a, 428b, and 428c, the Input Module 330 generates the listing of securities that meet the user's selections and provides this listing to the Security Sorting Module 340. FIG. 5 illustrates an exemplary output 500 of a Security Sorting Module, which shows the security categories (510) and the securities from the investment input of FIG. 4D classified into those categories (520). The categories shown in FIG. 5 are exemplary only and many additions, omissions, alternatives and variations to the categories are possible, and included within the scope of the present invention. In general, security category is associated with securities sharing certain common investment dynamics.

The system 300 according to the present invention also includes a Security Ranking Module 350 as shown in FIG. 3. The Security Ranking Module can rank the securities using one or more qualitative criteria, one or more quantitative criteria, or one or more combinations thereof. The ranking criteria for any two sorted categories can be either the same or different from each other. In general, the qualitative criterion is representative of the general quality of the security, while the quantitative criterion is representative of detailed numerical performance data.

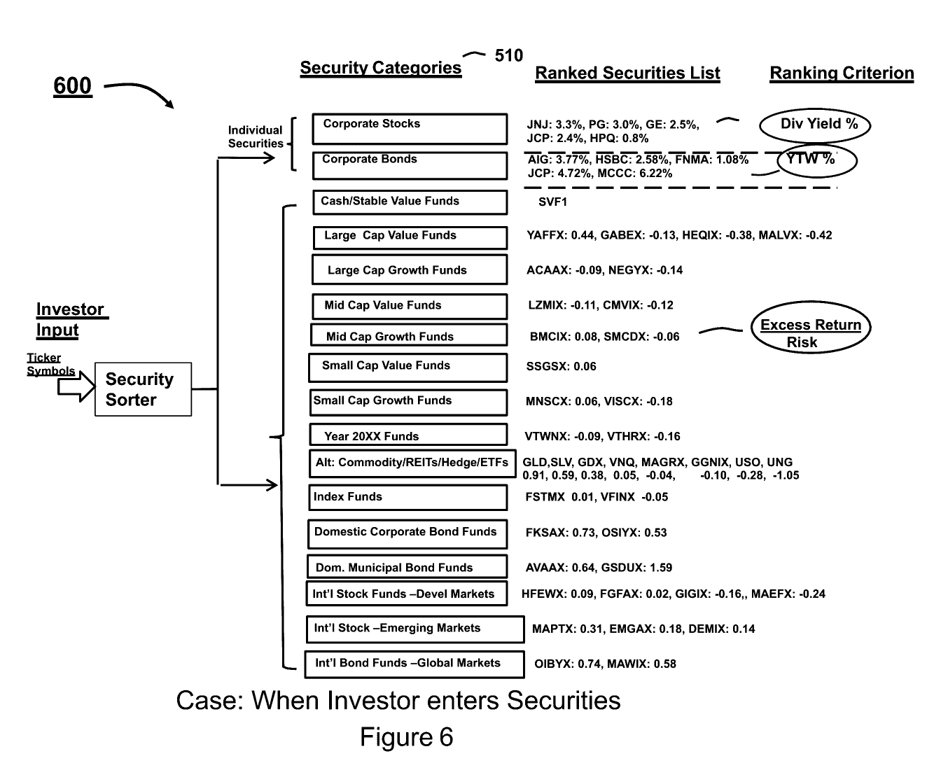

Qualitative ranking: In an embodiment, the qualitative ranking is performed using the commercially available market research information about the securities. The qualitative ranking can be performed for securities in all or a subset of the categories. In an exemplary embodiment, the qualitative ranking can be performed using the “star” rating of the securities (e.g., Morningstar star ratings). In an alternative embodiment, the qualitative ranking can be performed using the ratings given by the credit rating agencies. For example, the credit rating agencies such as Moody's, S&P etc. often rate the bonds as investment grade, junk etc. Though certain specific exemplary qualitative ranking criteria have been described above, other appropriate qualitative ranking criteria can also be used in lieu of or in addition to the exemplary ratings described above, and they are included within the scope of the present invention. Certain exemplary output 600 of a ranking module in the investment advising system according to a specific embodiment of the present invention is illustrated in FIG. 6. As shown in FIG. 6, the securities in each of the categories 510 are ranked according to predetermined qualitative, quantitative or combined qualitative and quantitative criteria.

Quantitative ranking: In an embodiment, the quantitative ranking is performed using the commercially available market research information about the securities. The quantitative ranking can be performed for securities in all or a subset of the categories. The quantitative ranking can be performed using any of the appropriate parameters. For example, Price to Earnings ratio (P/E) of the security can be compared to its industry peers as well as its relative Dividend to Price ratio (also known as Dividend Yield %) is analyzed. If security's P/E is lower than its industry peers, then it is a better value and vice versa. Higher the security's Dividend Yield %, more valuable it is. For P/E, trailing earnings and future expected earnings can be analyzed. As another example, bonds can be evaluated by their Yield To Worst (YTW) %. If bond is not callable, then its Yield To Maturity (YTM) % is same as its YTW %. If the bond is callable by the borrower before its expiration, then its YTW % will be lower than YTM %. Higher this yield, the better the investment in a given class of investments (Investment Grade and Junk). As yet another example, mutual funds and ETFs can be quantitatively ranked in individual security classes by analyzing their three year or five year Excess Return to Risk ratio. This ratio is also known as Sharpe Ratio. Higher the ratio for an investment, better the value it has over its lower ratio counterpart. While certain exemplary quantitative ranking criteria have been described, other appropriate quantitative ranking criteria can also be used in lieu of or in addition to the exemplary parameters described above, and they are included within the scope of the present invention.

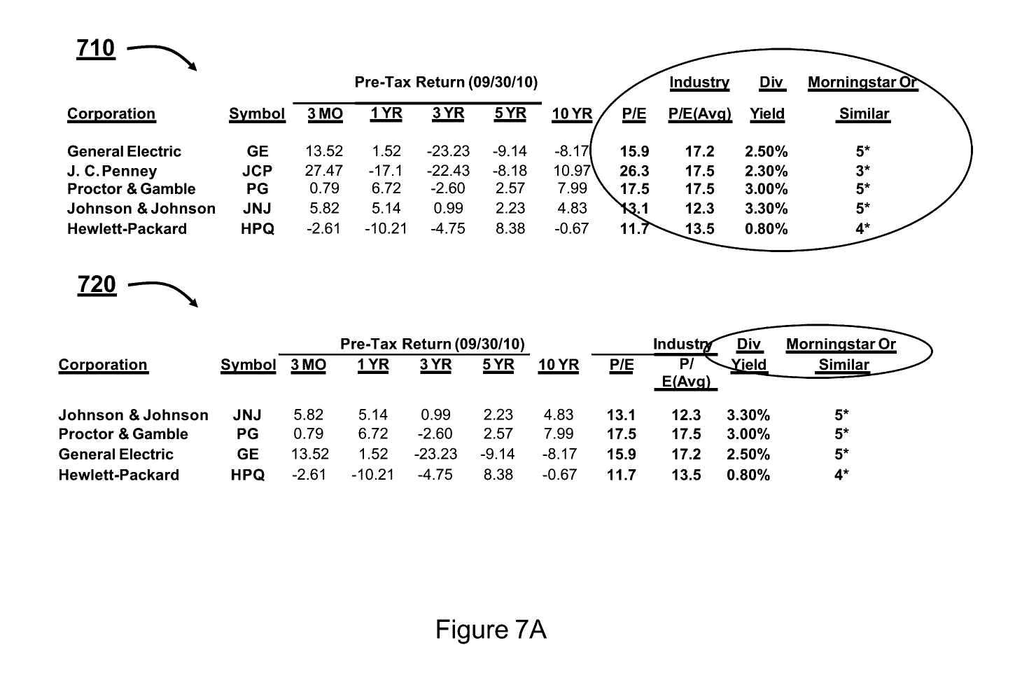

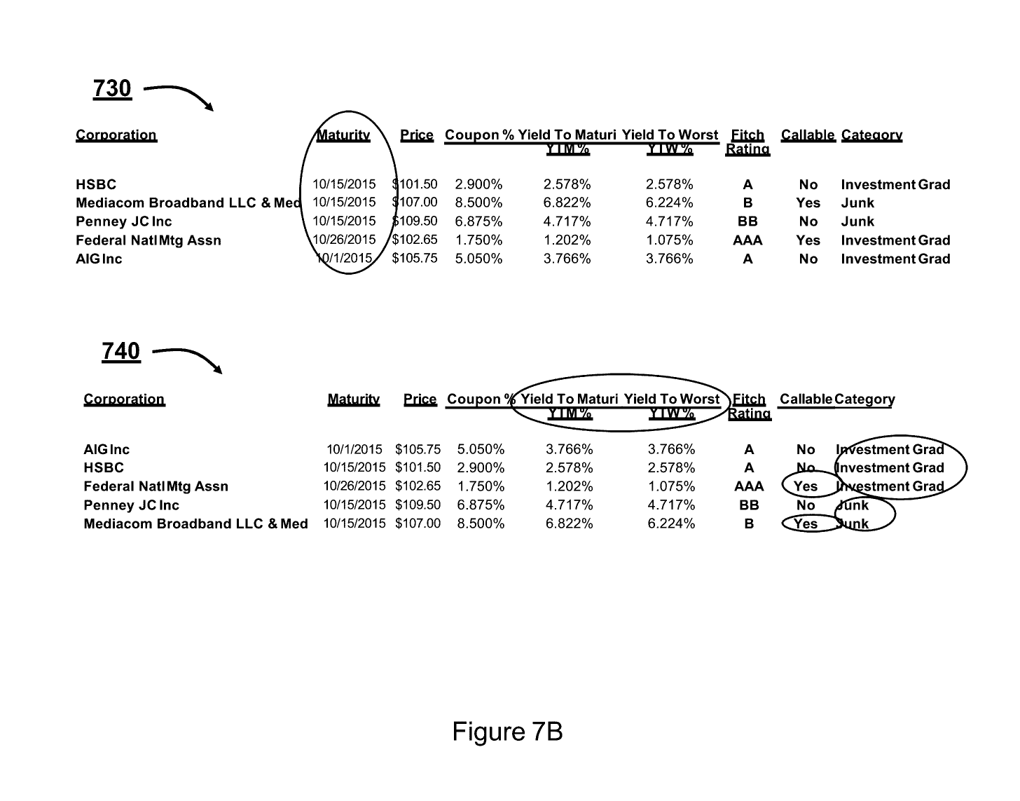

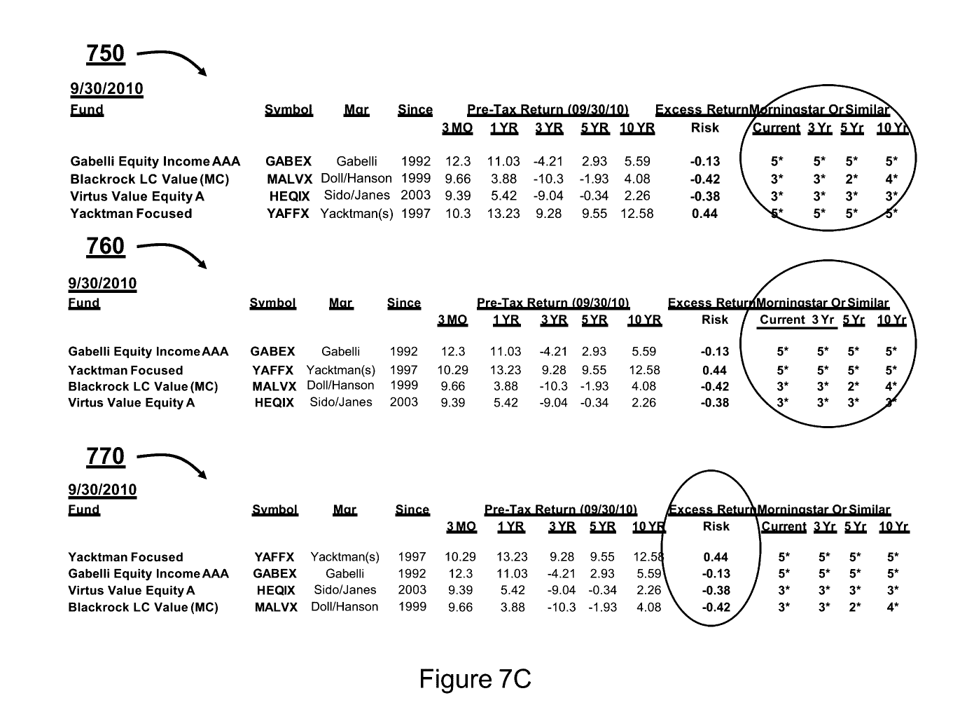

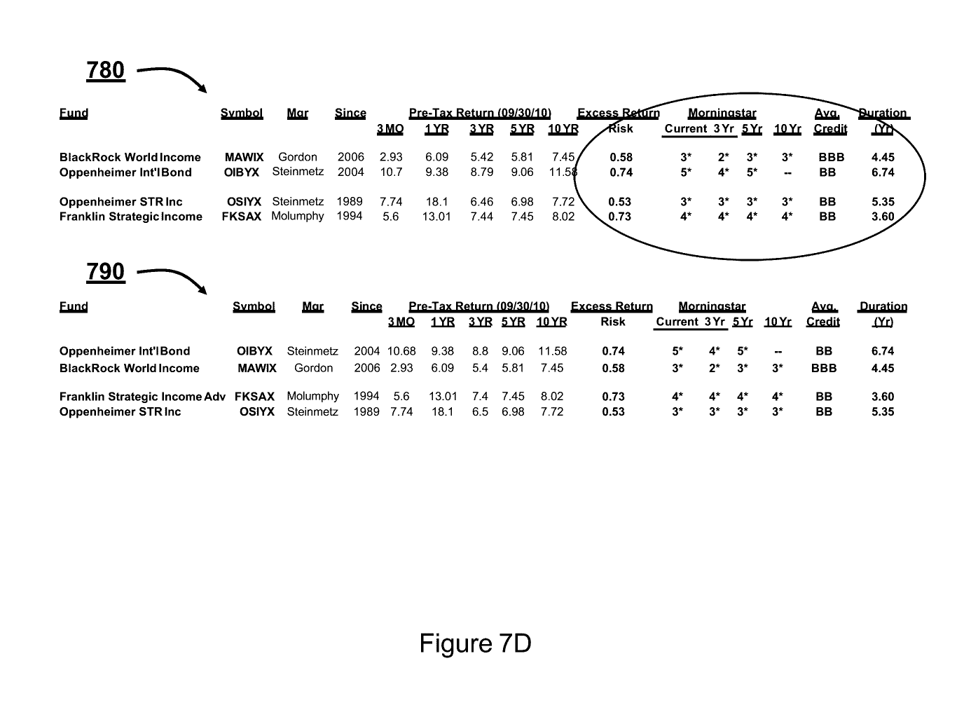

Certain exemplary qualitative and quantitative ranking methods are herein described with reference to FIGS. 7A, 7B, 7C and 7D. In particular, FIG. 7A illustrates exemplary market research information 710 and an exemplary ranking 720 in the Corporate Stocks category based upon certain exemplary ranking criteria. As seen in ranking 720, both qualitative and quantitative rankings are applied. Per qualitative ranking, stocks with higher Morningstar ratings are ranked higher up followed by the lower rated stocks. Per quantitative ranking, higher the Dividend Yield higher the rank within the same qualitative group. As another example of the quantitative ranking, P/E compared to industry average can also be used to rank the stock. As yet another example, for individual company stock, a lower P/E based on future expected earnings compared to its trailing earnings counterpart can be considered better value and vice versa. While certain exemplary ranking has been illustrated in FIG. 7A, other appropriate ranking criteria can also be used in lieu of or in addition to the exemplary parameters described above, and they are included within the scope of the present invention. As merely yet another example, the ranking criterion can be a weighted average of a plurality of qualitative and/or quantitative parameters.

FIG. 7B illustrates exemplary market research information 730 and an exemplary ranking 740 in the bonds category based upon certain exemplary ranking criteria. For ease of understanding, the example uses similar maturities for all bonds. As seen in ranking 740, both qualitative and quantitative ranking methodology is applied. Qualitatively, investment grade bonds have lower risk than junk bonds. Non-callable' bonds have same YTM and YTW, while for the callable bonds YTW is lower than its YTM. In either case, use of YTW allows to compare attractiveness of bonds with higher the YTW better the returns for a given grade bond. While certain exemplary rankings have been illustrated in FIG. 7B, other appropriate ranking criteria can also be used in lieu of or in addition to the exemplary parameters described above, and they are included within the scope of the present invention. As merely yet another example, the ranking criterion can be a weighted average of a plurality of qualitative and/or quantitative parameters.

FIG. 7C illustrates exemplary market research information 750 and certain exemplary rankings 760 and 770 in the large cap value mutual funds category based upon certain exemplary ranking criteria. As seen in ranking 760, qualitative ranking methodology is applied per ratings of market research agency such as Morningstar. In 770, quantitative ranking methodology of excess return per risk with higher being better is further applied. While certain exemplary rankings have been illustrated in FIG. 7C, other appropriate ranking criteria can also be used in lieu of or in addition to the exemplary parameters described above, and they are included within the scope of the present invention. As merely yet another example, the ranking criterion can be a weighted average of a plurality of qualitative and/or quantitative parameters.

FIG. 7D illustrates exemplary market research information 780 and certain exemplary ranking 790 for the bond based mutual fund category. In 790, both qualitative and quantitative ranking methodologies are applied for each geographical sector. Qualitative rating ranks utilize Morningstar rating per outside agency, higher star rating being better fund. The quantitative ranking methodology of excess return per risk with higher being better is further applied.

Moreover, the system 300 according to the present invention includes a Risk Filtering Module 360. As previously described, the investor input includes risk level of the investor. For example, the investor can select among conservative, moderate and aggressive levels (425-427 in FIG. 4). Based on the risk level, the Risk Filtering Module can assign weights to different securities categories.

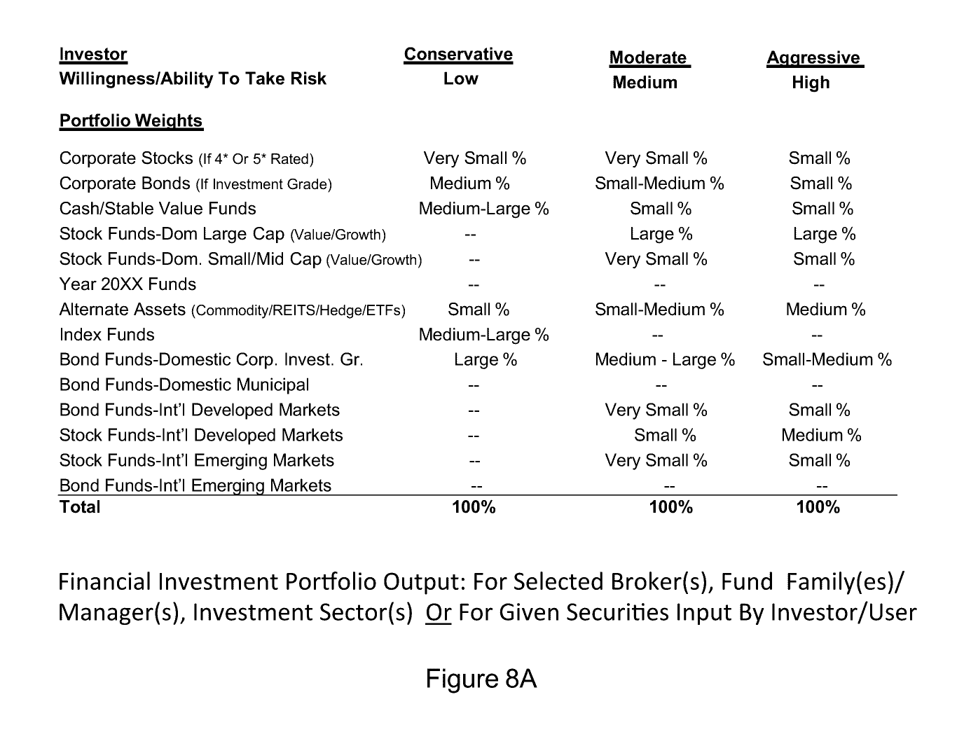

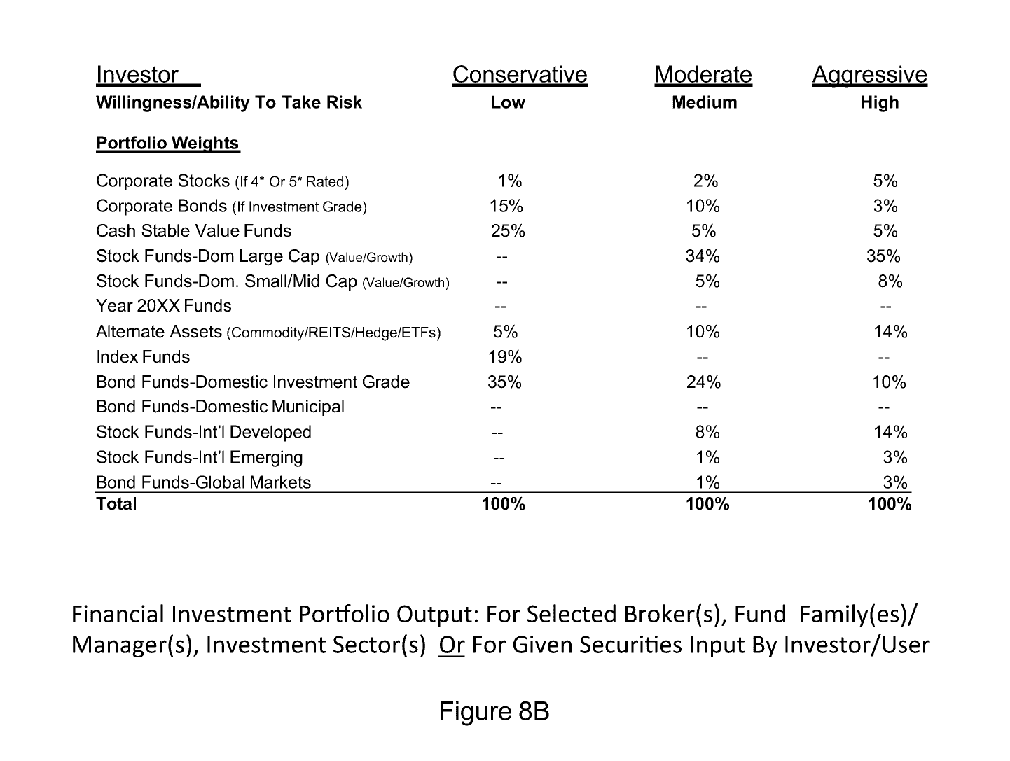

In a specific embodiment, the Risk Filtering Module uses different templates of weight assignments for different risk levels. For example, a template for a given risk level indicates weights to be assigned to different securities categories. Depending upon the risk level inputted by the user (at illustrated at 425-427 in FIG. 4A), the template for that risk level can be applied for apportioning the investment into different securities categories. Certain risk-based investment rules/knowledge can be used while creating these templates. As merely examples, cash/CDs have minimal risk, domestic bonds have lower risk than domestic stocks due to senior claim to company assets, small cap companies are riskier investment than mid cap companies, mid cap companies are riskier investment than large cap companies, international developed market investment is riskier than domestic market investment, international emerging market investment is riskier than international developed market investment, most alternate investment securities are based on least liquid assets (real estate, private equity etc.), hedge funds have longer investment horizons, commodities are volatile and are tied to inflation etc. Certain exemplary templates which can be used by the Risk Filtering Module are illustrated in FIGS. 8A and 8B. Notably, these illustrated templates are merely examples, and various alternatives and modifications are possible, all of which are included within the scope of the present invention.

Referring again to the embodiment of FIG. 3, the system 300 includes a Report Generation Module 370. In a specific embodiment, the Report Generation Module selects zero or more securities from each of the securities categories, based upon the weights assigned to the category by the Risk Filtering Module. As merely an example, the selection rule can be: Individual company stock investment in a portfolio should not exceed more than 5% for a stock with Morningstar rating of 4* or 5*, company stock with rating of 3* should be less than 2% of portfolio value, and 1* or 2* rated company stock should have less than 1% at most. If security category (other than individual company stock) weight is less than 5% then choose the best security in that class; if category weight is 6-20%: choose top two securities in proportions of 65% and 35%; if category weight is 21-30%: choose top three securities in proportions of 60/30/10%; if category weight is 31-50%: choose top 4 securities in proportions of 55/25/15/5%. While exemplary selection rule is described above, other appropriate selection rules can also be used in lieu of or in addition to the exemplary rule described above, and they are included within the scope of the present invention. For example, an alternative selection rule can be: choose up to top 3 securities in each category with non-zero weights in equal proportions.

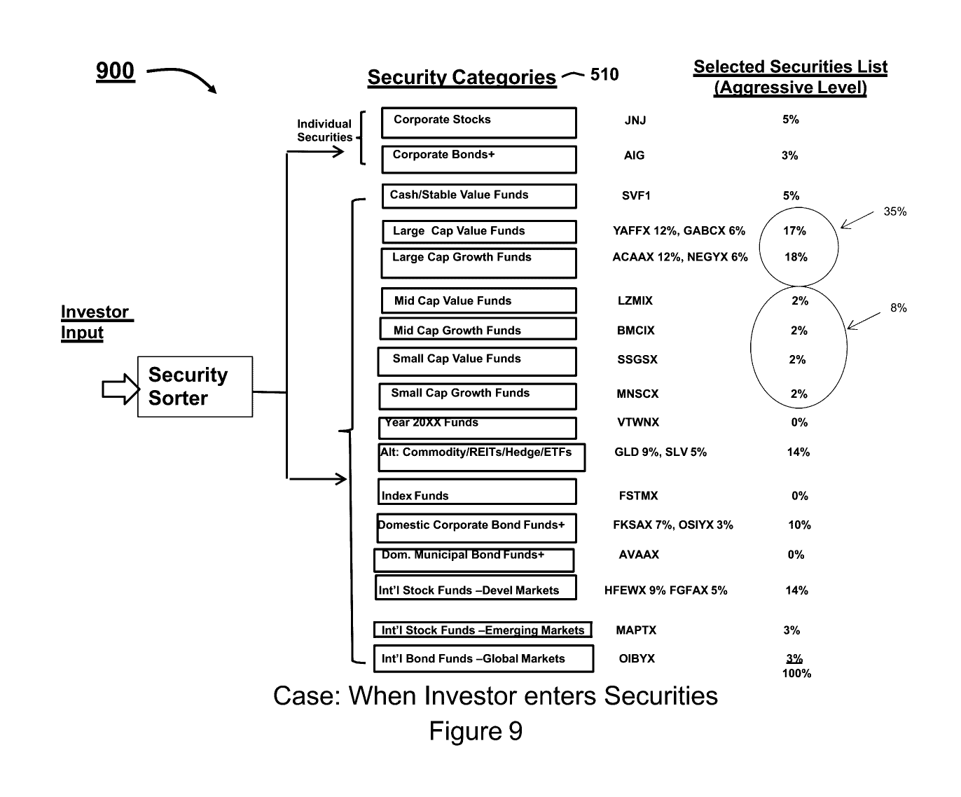

Based upon the selected securities, the Report Generation Module outputs investment advice report. The report indicates apportioning of the investment among the securities identities specified in the user input. The report can be communicated to the user in variety of ways such as display on computer screen, email, archiving in user account etc. FIG. 9 illustrates an exemplary investment advice report 900. This illustrated report is merely exemplary, and various alternatives and modifications are possible, all of which are included within the scope of the present invention.

In an embodiment of the present invention, the feedback time interval (as inputted at field 434 of screen 420, or specified by other appropriate methods) is used to automatically repeat at least a subset of the investment analysis described above and to re-generate the investment advice report. This facilitates adjusting the investment portfolio according to dynamics of the market.

In an alternative embodiment, at least a subset of the investment analysis described above is performed substantially continuously, e.g., every hour, every day, every week, every month, at predetermined intervals etc., either by default or based on investor instruction. In this embodiment, the output of the present analysis is compared with the outputs of the one or more past analyses. If a substantial difference according to predetermined criteria is detected between the present output and the one or more past outputs, an alert can be generated and transmitted to the investor.

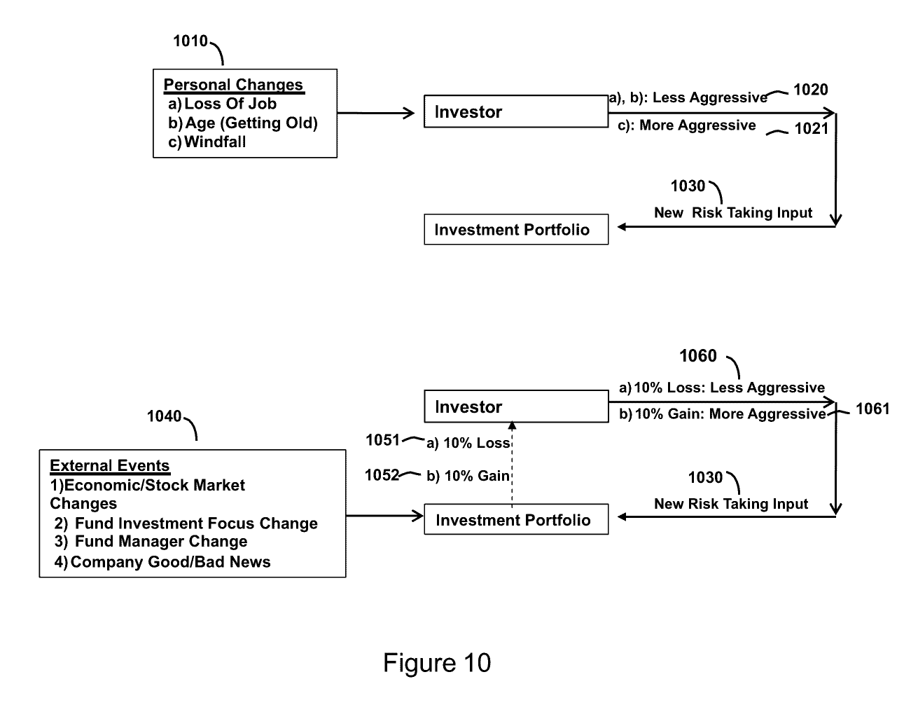

In an embodiment, at least a subset of the investment analysis described responsive to certain triggers, such as, change in investor's personal situation (1010), change in market environment (1040) etc. An exemplary flow of process according to this embodiment of the present invention is illustrated in FIG. 10. For example, personal changes such as loss of job, getting old may make the investor less aggressive (1020) investor. On the other hand, winning a lottery or getting inheritance may make the investor more aggressive (1021) investor. Market events (1040) such as sudden gain or loss in stock market due to good or bad economic news can affect investment portfolio value. For example, if the portfolio value increases by more than a threshold (1052), then the investor may decide to become more aggressive (1061). On the other hand, if there is threshold loss (1051), it may make the investor less aggressive (1060). Mutual fund's investment focus change or mutual fund's manager change, individual company releasing either good surprise or bad surprise are other types of external changes that may affect investor also.

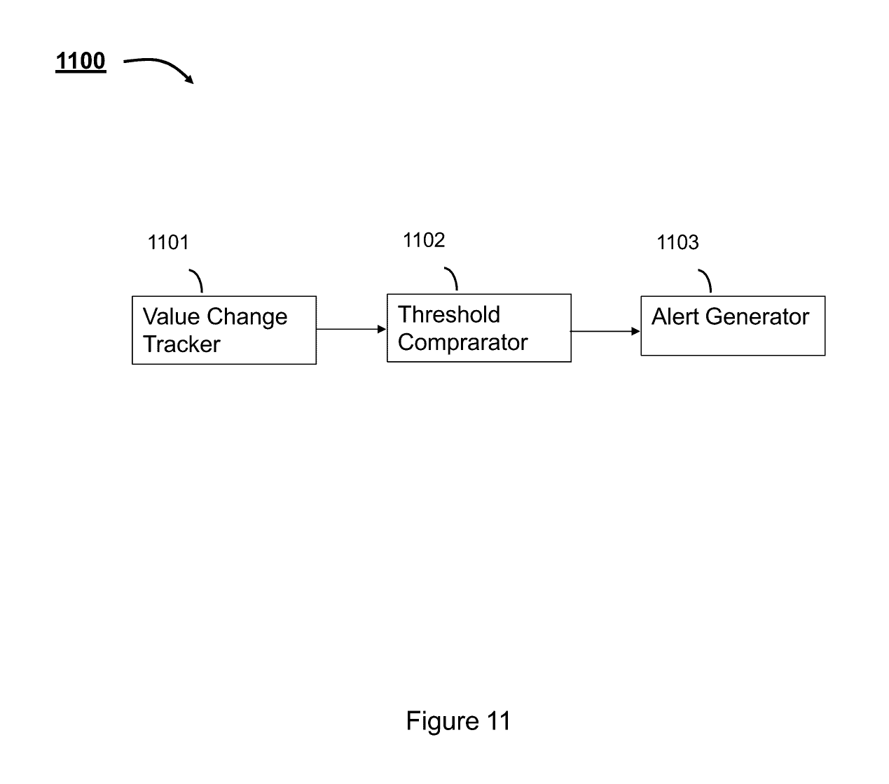

Accordingly, in an embodiment of the present invention, a “Feedback Module” 1100 (FIG. 11) is included in the investment advisor system. The Feedback Module comprises “Value Change Tracker” (1101) which tracks changes in value of the portfolio. Moreover, the Feedback Module comprises “Threshold Comparator” (1102) which compares the changes in portfolio value with a predetermined threshold. This threshold may be indicated by the investor or chosen by the system. The “Alert Generator” in the Feedback Module (1103) generates alert to the investor when the threshold is met. The alert may advise the investor to change risk level in response, or may automatically change the risk level for the investor. When a new risk level is selected, at least a subset of investment analysis (sorting, ranking, selecting etc.) can be performed to generate a new investment advice report that is consistent with the new risk level.

In yet a further alternative embodiment, techniques according to the present invention can be used to generate non-personalized, but risk level based investment advisories. In this embodiment, the inputting step (as illustrated in screenshot 420 of FIG. 4B) can be performed by a third party, and investment advice reports can be generated for one or more risk levels. Preferably, such reports can be made available to intending investors (e.g., by posting on website, via email distribution etc.).

Accordingly, the system of the present invention provides an investment advisor system. Specific operation of the system described herein is exemplary only. Various alternatives and modifications will be apparent to person of ordinary skill in the art based upon teachings in the present specification. For example, in alternative embodiments, the various modules can act on the data in an order different from that described in specific embodiments. For example, in an alternative embodiment, the ranking module may assign qualitative and/or quantitative ranks to the securities before processing by the Sorting Module. Yet alternatively, one or more modules can perform processing in parallel. Such alternatives are included within the scope of the present invention.

In alternative embodiments, the invention provides investment advising and related methods. In a specific embodiment, the investment advising method includes receiving input comprising information associated with identification of a plurality of securities and a risk level, receiving a market research information associated with the securities identified in the input, processing the input in combination with the market research information, and generating an investment advice report indicating apportioning of investment among the securities identified in the input.

What is claimed is:

1. A computer based system for generating an investment advice report, the system comprising:
a processor unit;
a computer readable medium storing instructions executable by the processor unit to perform the steps of:
receiving a first input comprising information associated with identification of an investment broker and at least one selected from the group consisting of one or more fund families associated with the investment broker and one or more investment sectors associated with the investment broker;
receiving a second input about a risk level, wherein the risk level indicating risk appetite of a user who wishes to invest a sum of money;
identifying a plurality of securities associated with the first input;
receiving a first market research information associated with the identified securities;
processing the risk level in combination with the first market research information; and
generating a first investment advice report indicating apportioning of the sum of the money among the identified securities, wherein
the apportioning being in accordance with at least the risk level, and
the apportioning at least indicating a first portion, a second portion, a third portion, and a fourth portion of the sum of the money to be invested in a first category of stock securities, a second category of bond securities, a third category of mutual fund securities, and a fourth category of exchange traded fund securities, respectively.

2. The system of claim 1 wherein the risk level is indicated as low, medium, or high.

3. The system of claim 1 wherein the risk level is indicated as conservative, moderate, or aggressive.

4. The system of claim 1 wherein the computer readable medium storing further instructions executable by the processor unit to perform the steps of:
classifying the identified plurality of securities associated with the first input into a plurality of security categories, the plurality of the security categories including the first category of stock securities, the second category of bond securities, the third category of mutual fund securities, and the fourth category of exchange traded fund securities; and
assigning a plurality of weights to the plurality of the security categories, respectively, in accordance with the risk level identified in the second input.

5. The system of claim 4 wherein the first investment advice report indicating the apportioning of the sum of the money among the plurality of the security categories in accordance with the plurality of the weights assigned to the plurality of the security categories.

6. The system of claim 1 wherein the computer readable medium storing further instructions executable by the processor unit to perform the step of:
receiving a third input comprising information associated with a feedback time interval.

7. The system of claim 6 wherein the computer readable medium storing further instructions executable by the processor unit to perform the steps of:
ascertaining that the feedback time interval has elapsed since the generating the first investment report;
receiving a second market research information associated with the identified securities;
processing the first input, the second input and the third input, the processing being in combination with the second market research information; and
generating a second investment advice report indicating apportioning of the sum of the money among the identified securities.

8. The system of claim 7 wherein the first market research information and the second market research information about a security comprises qualitative information about the security.

9. The system of claim 8 wherein the qualitative information about the security comprises at least a star rating for the security or at least a bond rating for the security.

10. The system of claim 7 wherein the first market research information and the second market research information about a security comprises quantitative information about the security.

11. The system of claim 10 wherein the quantitative information about the security comprising Sharpe ratio information.

12. The system of claim 1 wherein the computer readable medium stores further instructions executable by the processor unit to perform the steps of:
computing change (gain or loss) in the sum of the money invested at a first time in accordance with the first investment advice report, the change being computed from the first time to a second time that is later than the first time;
ascertaining that the change exceeds a predetermined threshold; and
receiving a fourth input associated with change in the risk level responsive to the ascertaining.

13. A computer based system for generating an investment advice report, the system comprising:
a processor unit;
a computer readable medium storing instructions executable by the processor unit to perform the steps of:
receiving a first input comprising information associated with identification of an investment broker and at least one selected from the group consisting of one or more fund families associated with the investment broker and one or more investment sectors associated with the investment broker;
identifying a plurality of securities associated with the investment broker and the one or more fund families;
receiving a second input identifying a first risk level, wherein the first risk level indicating a first risk appetite of a user who wishes to invest a sum of money;
receiving a third input identifying a second risk level, wherein the second risk level indicating a second risk appetite of a user who wishes to invest a sum of money;
receiving market research information associated with the identified securities;
processing the second input and the third input, in combination with the market research information;
generating a first investment advice report indicating apportioning of the sum of the money among the identified securities, the apportioning being according to the first risk level and the apportioning at least indicating a first portion, a second portion, a third portion, and a fourth portion of the sum of the money to be invested in a first category of stock securities, a second category of bond securities, a third category of mutual fund securities, and a fourth category of exchange traded fund securities, respectively; and
generating a second investment advice report indicating apportioning of the sum of the money among the identified securities, the apportioning being according to the second risk level and the apportioning at least indicating a fifth portion, a sixth portion, a seventh portion, and a eighth portion of the sum of the money to be invested in the first category of stock securities, the second category of bond securities, the third category of mutual fund securities, and the fourth category of exchange traded fund securities, respectively,
wherein the apportioning in the first investment advice report being different from the apportioning in the second investment advice report.

14. The system of claim 13 wherein the computer readable medium storing further instructions executable by the processor unit to perform the steps of:
classifying the identified securities into a plurality of security categories, the plurality of the security categories including the first category of stock securities, the second category of bond securities, the third category of mutual fund securities, and the fourth category of exchange traded fund securities, respectively; and
ranking securities in each of the plurality of the security categories using at least one qualitative criterion, at least one quantitative criterion, or combination of at least one qualitative and at least one quantitative criterion.

15. The system of claim 14 wherein the processing any of the second input or the third input further comprising selecting for investment one or more securities from the each of the plurality of the security categories based at least upon the ranking of securities within the each of the plurality of the security categories.

16. The system of claim 14 wherein the ranking within the first category of stock securities, the second category of bond securities, the third category of mutual fund securities, and the fourth category of exchange traded fund securities, respectively are based upon at least one criterion selected from the group consisting of star rating and Sharpe ratio.
